(19) United States
(12) Patent Application Publication
(10) Pub. No.: US 2007/0036195 A1
(43) Pub. Date: Feb. 15, 2007

(54) Active element for a laser source and laser source comprising such an active element

(75) Inventors: Jean-Eucher Montagne, Orleans (FR); Louis Cabaret, Plessis St Benoist (FR)

Correspondence Address: STEVENS DAVIS MILLER & MOSHER, LLP, 1615 L STREET, NW, SUITE 850, WASHINGTON, DC, 20036, US

(73) Assignee: COMPAGNIE INDUSTRIELLE DES LASERS CILAS, Orleans (FR)

(21) Appl. No.: 11/408,060

(22) Filed: Apr. 21, 2006

(30) Foreign Application Priority Data
Apr. 28, 2005 (FR) 05 04280

(51) Int. Cl. H01S 3/16; H01S 3/06; H01S 3/091

(52) U.S. Cl. 372/71; 372/41; 372/66

(57) ABSTRACT

The active element (1) comprises an elongate rod (2) that comprises a doped matrix capable of absorbing at least one pump beam (3) in order to amplify at least laser radiation (4) propagating longitudinally, the length and the doping of said elongate rod (2) being such that the proportion of pump energy absorbed by said elongate rod (2) is greater than 90% for the wavelength of an operational spectral range having the lowest absorption coefficient.

The present invention relates to an active element for a laser source and to a laser source comprising such an active element.

More precisely, said laser source is of the type comprising:
an active element comprising an elongate rod, of generally, but not exclusively, circular cross section, comprising a doped matrix capable of absorbing a pump beam in order to amplify at least laser radiation propagating longitudinally with or without rebound;
a pumping system, comprising pump (laser) diodes capable of emitting a pump beam;
an optical transport system for directing the pump beam emitted by said pumping system into said active element so as to obtain longitudinal pumping; and
an optical cavity for extracting said laser radiation.

It is known that, to be effective, the pump beam must be spectrally tuned to the absorption spectrum of the active element in such a way that said pump beam is absorbed and transfers its energy into the ions (for example rare-earth or transition metal ions) that dope said active element.

It is also known that pump (laser) diodes have an emission spectrum, generally a few nanometers in width, which is shifted by 0.25 to 0.3 nanometer per degree when the temperature of said pump diodes changes.

To ensure satisfactory conformity of the wavelength of the pump beam (output by said pump diodes) with the absorption spectrum of the active medium, it is known to mount said diodes on Peltier modules, the function of which is to stabilize their temperature with an accuracy of better than 0.5° C. so as to ensure wavelength centering to within 0.2 nm.

However, especially in the case of military applications, compactness, consumption and implementation rapidity parameters assume a particular importance. Thus, the use of Peltier modules, which involves considerable consumption and requires a stabilization time of the order of one minute, is a retarding factor on the use of diode-pumped laser sources in compact systems. The same applies in the case of other active systems for stabilizing the temperature of the diodes. Thus, the technology always employed at the present time, for example for terrestrial laser designators, is that of a flash pump, which is not very efficient and is bulky.

To try to remedy this problem, it is necessary:
either to increase the tolerance of the active medium to the wavelength drift, which is proposed for example by Patent FR-2 803 697, for which the pump beam is guided in order to pass several times through the active medium;
or to passively stabilize the emission of the wavelength of the pump diodes, as proposed for example in patent application US-2005/0018743, which describes the use of a system including one or more VBGs (Volume Bragg Gratings) so as to condition one or more of the emission characteristics of the laser.

However, the above solutions only allow an insensitivity over 3 to 10 nanometers to be obtained, corresponding to a temperature drift of the diodes of 15 to 40° C. Such a thermal insensitivity range is largely insufficient for using the pumping system, for example in a terrestrial laser designator, between −40° C. and +70° C.

The object of the present invention is to provide an active element and a laser source for achieving thermal insensitivity of laser emission over more than 15 nanometers.

It should be noted that, with regard to longitudinal pumping, the main difficulty of pumping at high power levels (above 500 W) lies in the generation of parasitic effects, such as amplified stimulated emission (hereafter called ASE) or parasitic emission modes (hereafter called MEP modes). ASE derives from spontaneous radiation naturally emitted by the ions excited by the pump beam and amplified by the gain resulting from the presence of these excited ions. MEP modes derive from the combination of:
reflections at the edges of the active element and/or on any other reflector; and
the laser gain deriving from the excited ions.

The combination of these two factors causes parasitic laser emission along one or more axes that are usually different from the main laser axis.

ASE is a parameter essentially governed by the gain and the maximum possible gain length in the active element. The only possible way of reducing this effect is to limit gain length or the value of the gain.

The MEP modes are also governed by the gain and the presence of parasitic reflections that reflect photons back toward the laser and thus allow gain cycling of these photons.

Moreover, the following are known:
from document EP-0 583 944, an active element for a laser source, which includes a first coating that reflects the pump beam and a second coating that absorbs the laser radiation;
from document U.S. Pat. No. 5,572,541, an active element for a laser source, which also includes a first coating that reflects the pump beam and a second coating that absorbs the laser radiation; and
from document DE-195 31 756, an absorption means intended for absorbing the laser radiation.

The object of the present invention is to remedy the aforementioned drawbacks. It relates to an active element for a laser source, making it possible to achieve substantial thermal insensitivity, while limiting the generation of parasitic effects of the aforementioned type (ASE and MEP modes).

For this purpose, according to the invention, said active element of the type comprising:
an elongate rod which comprises a doped matrix capable of absorbing at least one pump beam in order to amplify at least laser radiation propagating longitudinally;
a first coating that is placed on the periphery of said rod and is capable of reflecting at least some (preferably at least 80%) of said pump beam; and
an absorption means for absorbing at least some (preferably at least 70%) of the radiation that passes through the periphery of said rod and has a wavelength substantially equal to that of said laser radiation, is noteworthy in that the length and the doping of said elongate rod are such that the proportion of pump energy absorbed by said elongate rod is greater than 90% for the wavelength of an operating spectral range that has the lowest absorption coefficient.

Thus, thanks to said first coating, the pump beam can be guided and kept essentially (to least 80%) within said rod, thereby making it possible to obtain particularly effective pumping. In addition, thanks to said absorption means, the parasitic radiation passing through the rod is essentially adsorbed, thereby suppressing the MEP modes and minimizing the ASE length.

It is known that the proportion of pumping energy absorbed by the active element depends, on the one hand, on the absorption coefficient α_{λ} of the active element and, on the other hand, on the length of material L through which the pump beam passes. This proportion of absorbed energy Abs is given by the equation Abs=1−exp(−α_{λ}L). Thus, to optimize said proportion Abs, it is necessary to maximize, firstly, said absorption coefficient α for all wavelengths λ of interest, and secondly said length L through which the pump beam passes. According to the invention, in order for the proportion of pump energy absorbed Abs to remain substantially greater than about 90% over the entire intended spectral range, the absorption length L is therefore matched to the lowest coefficient α_{λ}.

Moreover, it is known to be difficult to suitably extract the energy from a large volume of active medium (the active element) in which the pump energy is dispersed. Furthermore, the proposed configuration is a longitudinal pumping configuration for which the beam absorption length may be long, provided that this is collinear (or almost collinear) with the axis of the laser source. According to the invention, the active medium is therefore designed to receive and convey a pump beam propagating collinearly (or almost collinearly) with the axis of the elongate rod.

In a first embodiment, said first coating is formed so as to correspond also to said absorption means, that is to say the absorption of said radiation (which has the wavelength of the laser radiation) is produced directly by this first coating, which therefore has two functions, namely reflection and absorption. In this case, the material of said first coating is preferably filled with an absorbent substance of organic or inorganic nature.

In a second embodiment, said absorption means corresponds to a second coating, which is placed on the external face of said first coating.

In the latter case, in one particular alternative embodiment, said elongate rod has a circular cross section, said first coating comprises an interface material (in particular an adhesive, a polymer or an inorganic material), which provides a thermal and mechanical junction, provided on the periphery of said rod, and has a lower refractive index than said rod, and said second coating comprises a mount made of absorbent material, which surrounds said rod provided with said interface material.

In an alternative embodiment that can be combined with either of the first and second embodiments above, said first coating comprises a thin film that has a lower refractive index than said rod. In another alternative embodiment that can be combined with either of the above first and second embodiments, said first and/or second coating is produced from a microstructure material.

Furthermore, in an alternative embodiment, said rod has plane lateral faces and said first coating comprises plates that are welded to said plane lateral faces of said rod and are made of a material having a lower refractive index than said rod.

Advantageously, said rod is formed from at least a material having a longitudinal variation in doping with the lowest doping, limited to a predetermined value, for example 0.5%, at the entrance face for the pump beam. Thus, the gain is varied, by limiting the doping at the start of the rod (at said entrance face) in order to limit the absorption in this region and therefore to limit the transverse gain. This makes it possible to reduce both the occurrence of ASE and that of MEP modes. In addition, the rod may have an undoped region in front of its entrance face.

By lowering the doping at the start of the rod, the absorption efficiency is reduced. It is therefore necessary to provide, after the first few millimeters of absorption, a higher doping level.

To maximize the absorption of the pump beam, said active element may advantageously comprise, at least in part, as material an Nd:YVO4 crystal.

In a first embodiment, said material of the active element has a continuous longitudinal variation in doping, whereas in a second embodiment it has a stepped longitudinal variation in doping.

Said material preferably comprises, in the first embodiment, a ceramic with a doping gradient and, in the second embodiment, several differently doped crystals. These two embodiments may also be combined.

Furthermore, in one particular alternative embodiment, said material comprises both an Nd:YAG crystal and an Nd:YVO4 crystal. Since the absorption bands of these two crystals are different, the insensitivity range is thus extended. In addition, said Nd:YAG crystal is preferably placed upstream of said Nd:YVO4 crystal.

The present invention also relates a laser source comprising:
an active layer for a laser source;
a pumping system provided with pump laser diodes that are capable of emitting at least one pump beam;
an optical transport system for directing the pump beam emitted by said laser diodes into said active element so as to obtain longitudinal pumping; and
an optical cavity for extracting at least laser radiation.

According to the invention, said laser source is noteworthy in that said active element is of the aforementioned type.

Advantageously, said pumping system is formed so as to generate a pump beam:
with stability of the energy deposited, stable to better than 20% over several tens of degrees; and/or
which lies within a predetermined solid angle relative to said rod.

In one particular embodiment, said pumping system comprises modules (or stacks) of diodes, these being formed from semiconductors obtained from various wafers. The sum of the spectral emissions from the various semiconductors thus generates a broader spectrum than that of a single diode. In addition, each module of diodes may advantageously include a cooling means, thereby providing a specific thermal situation and also a spread function of the spectrum.

In another embodiment, said laser source may comprise a structure in which the laser diodes dissipate their energy.

Moreover, advantageously:
said laser source also includes means for generating at least two passes of the pump beam in the active element; and/or
said pumping system comprises two pumping units designed to pump the rod via its two ends.

The figures of the appended drawing will make it clearly understood how the invention can be realized. In these figures, identical references denote similar elements.

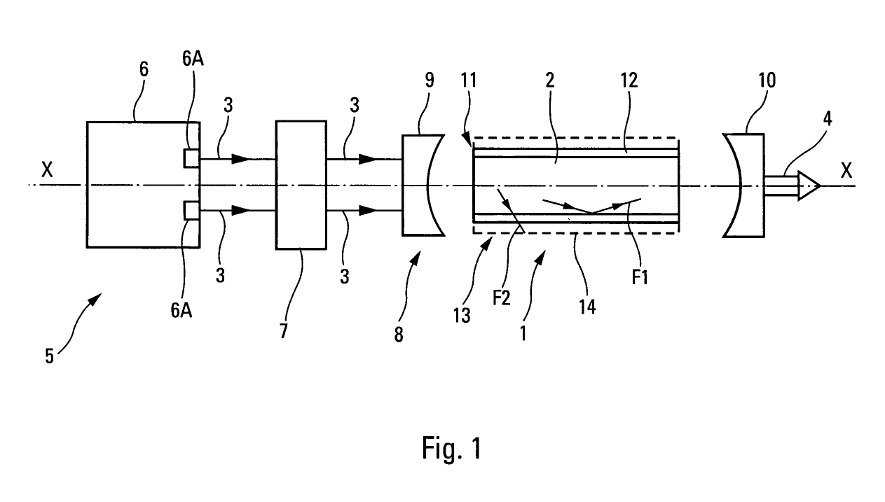

FIG. 1 is a simplified diagram of a laser source according to the invention.

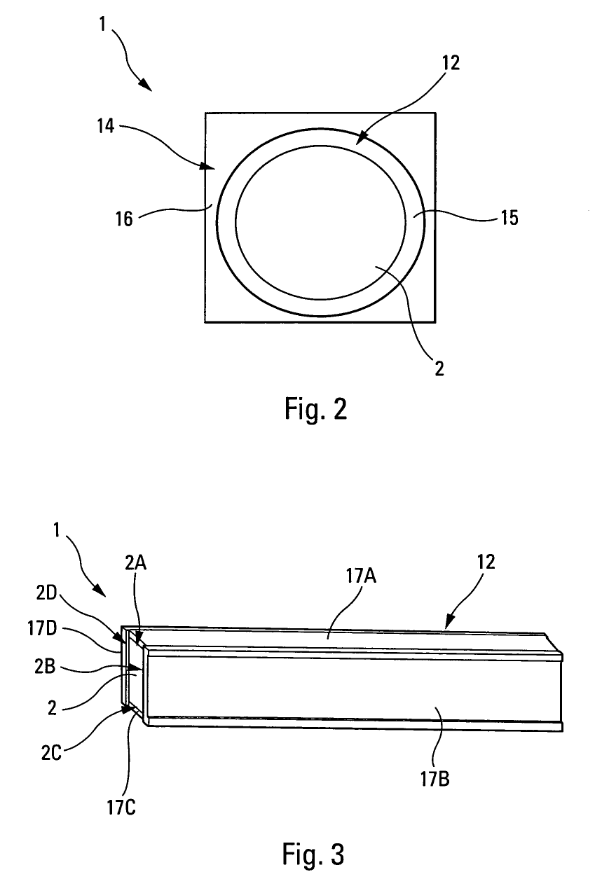

FIGS. 2 and 3 show schematically two examples of an active element according to the invention.

The active element i according to the invention comprises an elongate rod 2, which comprises a doped matrix capable of absorbing a pump beam 3, in order to amplify at least laser radiation 4 propagating longitudinally along an axis X-X.

This active element 1 can be integrated into a laser source 5, as shown for example in FIG. 1.

Said laser source 5 usually comprises, in addition to said active element 1:
a standard pumping system 6, which comprises laser-type pump diodes 6A and is capable of emitting at least one pump beam 3;
a standard optical transport system 7 for directing the pump beam 3 emitted by said pumping system 6 into said active element 1 so as to obtain longitudinal pumping; and
a standard optical cavity 8, of axis X-X, comprising in particular a reflecting mirror 9 and a slightly transparent mirror 10, which are placed facing each other. This optical cavity 8 gives the laser radiation 4 obtained by laser amplification and emitted through said mirror 10 along the X-X axis its directional and geometric characteristics.

According to the invention, said active element 1 also includes:
a coating 12, which is placed on the periphery of said rod 2 (that is to say on its external face or faces) and has a refractive index allowing at least 80% of said pump beam 3 to be reflected, as illustrated for a beam F1 in FIG. 1; and
an absorption means 13 for absorbing at least 70% of all radiation that passes through the periphery of said rod 2 and has a wavelength substantially equal to that of said laser radiation 4, as represented for a beam F2 in FIG. 1. 70% absorbed should be understood to mean that on average less than 30% of the radiation is reflected back toward the rod 2. It is known that the reflected fraction depends on the angle of incidence of the radiation in question.

Thus, thanks to said coating 12, the pump beam 3 can be guided and kept almost completely (at least to 80%) in said rod 2, thereby obtaining particularly effective pumping. In addition, thanks to said absorption means 13, explained in detail below, the parasitic radiation passing through the rod 2 is essentially absorbed, thereby suppressing MEP modes and minimizing the ASE length.

Moreover, according to the invention, the design constraints relating to the above characteristics are the following:
A/ the pump beam 3 is guided within a numerical aperture at least equal to that of the pump diodes 6A after passing through a focusing optic, which means a low refractive index of the coating 12;

B/ the length and the doping of the rod 2 are such that the proportion of pump energy absorbed Abs is greater than about 90% for the least absorbent pumping wavelength of the operational spectral range; and

C/ extraction from the active element 1 (rod 2) and/or absorption of the maximum quantity of fluorescence photons, which means that the refractive index of the peripheral region (coating 12, absorption means 13) is as close as possible to that of the active element 1 (rod 2).

The aforementioned constraints A and C are not completely compatible and therefore a compromise has to be found.

To guide the entire pump beam 3 inside the rod 2 (of index n_{YAG}), the total emission half-angle θ of the pump diodes 6A must correspond to the critical angle of incidence i_{c} at the interface of the coating 12 (of refractive index n). Thus, i_{c}=arcsin(n/n_{YAG}) and it is calculated that the refractive index n has a value that must not be substantially greater than n=\sqrt{n_{YAG}²−sin²θ}. For example, if θ is around 45°, with n_{YAG}=1.819, the index n is equal to 1.64.

The fluorescence emission also has the possibility of being trapped within a solid angle limited by an opening angle of (π/2−i_{c}) i.e. 25° in the example in question. In practice, this considerably increases the threshold at which MEP modes appear, provided that measures are taken to ensure that no closed path is contained within this solid angle. The unguided radiation is then absorbed in a material exhibiting selective absorption at the wavelength of the laser radiation 4 or is simply extracted from the rod 2.

In a first embodiment, said coating 12 is formed so as to correspond also to said absorption means 13, that is to say that the absorption of the radiation (which has the wavelength of the laser radiation 4) is produced directly by this coating 12, which therefore has two functions, namely reflection and absorption. In this first embodiment, the absorbent character of the coating 12 also reduces the appearance of MEP modes for the most grazing angles since, by absorption of the evanescent wave, the reflection is less effective. The internal reflection on the coating 12 depends, on the one hand, on the angle of incidence and, on the other hand, on the complex index of the coating 12, namely on its real part (n) and on its absorption coefficient, giving the imaginary part. This complex index is chosen in such a way that the level of reflection for each angle of incidence is low enough to preclude the MEP modes having this angle of incidence.

Furthermore, in this first embodiment in which said coating 12 corresponds to said absorption means 13, this assembly may be composed of an adhesive filled with an absorbent material in powder form or dissolved in the adhesive. This powder or this solution may be composed, for example, of rare-earth or transition metal ions or else organic materials that absorb the laser radiation.

Moreover, in a second embodiment, said absorption means 13 comprises a coating 14 that is placed on the external face (or the external faces) of said coating 12, as shown by the broken lines in FIG. 1.

In the latter case, in one particular embodiment shown in FIG. 2, said elongate rod 2 has a circular cross section, said coating 12 comprises an interface material 15 provided on the periphery of said rod 2 substantially with an annular shape and having a refractive index lower than that of said rod, and said coating 14 comprises a mount 16 made of absorbent material, which surrounds said rod 2, provided with said interface material 15. The term “interface material” is understood to mean any material providing a thermal and mechanical junction between the rod 2 and the mount 16 that surrounds it, without this interface material necessarily having pronounced bonding characteristics. For example, it may be a polymer, a standard adhesive or a sol-gel material. In order for the thermal transfer function between the rod 2 and the mount 16 not to be too compromised, it is preferred for the thickness of interface material 15 to remain less than 100 μm. Said mount 16 is capable of absorbing the emission of radiation at 1 micron that can propagate in this region. In the case of an Nd-doped YAG crystal with an angle θ of 45°, said adhesive 15 must have a refractive index close to 1.64. This index, which is substantially higher than that of most commercial adhesives, may for example be achieved using a commercial adhesive into which powder of a transparent material of high refractive index is introduced. This powder may in particular be a nanoscale powder, such as a TiO₂, Y₂O₃, Sm₂O₃, Sc₂O₃, Lu₂O₃, Gd₂O₃, ZrO₂ or YAlO₃ powder.

Another embodiment (not shown) of the active element 1 comprises a rod 2 of any cross section, the periphery of which is coated with a thin film 12 having a lower refractive index than said rod 2. Said thin film 12 is either absorbent at the wavelength of the laser radiation 4 or is surrounded by an absorbent coating 14.

In another embodiment shown in FIG. 3, the rod 2 has plane lateral faces 2A, 2B, 2C, 2D, for example of square cross section. Welded or bonded to the lateral faces 2A to 2D of this rod 2 are plates 17A, 17B, 17C, 17D, respectively, made of a material having a lower refractive index than the rod 2. In addition:
said plates 17A to 17D are thick enough for radiation with the wavelength of the laser radiation 4 to be unable to return to the rod 2; or
the material of said plates 17A to 17D is absorbent for said wavelength of said laser radiation 4; or
said plates 17A to 17D are coated on their external face with a coating (not shown) which is absorbent for said wavelength of the laser radiation 4.

Moreover, in one particular embodiment, said rod 2 of the active element 1 is formed from at least one material having a longitudinal variation in doping, along the X-X axis, with the lowest doping, which is limited to a predetermined value, for example 0.5%, on the upstream face 11 (or entrance face for the pump beam 3) of said active element 1.

Thus, by limiting the doping at the start of the rod 2 (on said upstream face 11), the absorption in this region is limited as is therefore the transverse gain, thereby making it possible to reduce the occurrence both of ASE and of MEP modes.

Lowering the doping at the start of the rod 2 decreases the absorption efficiency. It is therefore important to provide, beyond a predetermined distance, for example a few millimeters downstream of the upstream face 11, a higher doping.

Furthermore, to maximize the absorption of the pump beam 3, the rod 2 of the active element 1 preferably comprises, as material, at least in part, an Nd:YVO4 crystal.

In a first embodiment, said material of the rod 2 has a continuous longitudinal variation in doping, whereas, in a second embodiment, it has a stepped longitudinal variation in doping.

In the first embodiment, said material is preferably a material with a doping gradient. Such materials may be produced in a standard manner by a ceramic process.

It is also possible to employ several progressively doped crystals in order to achieve, at the entrance of each of them, the maximum gain for onset of ASE.

One possible improvement consists in combining an Nd:YAG crystal with an Nd:YVO4 crystal. Since the absorption bands of these two crystals are different, the insensitivity range is thus extended. In particular, the absorption of the Nd:YVO4 crystal is stronger at around 808-815 nm, whereas the Nd:YAG crystal has an absorption band at 792-797 nm that the Nd:YVO4 crystal does not have. Such a combination is possible since the two crystals each emit at 1064 nm.

In this case, if the Nd:YAG crystal is also placed upstream of said Nd:YVO4 crystal, an additional advantage is obtained. This is because the Nd:YAG crystal will be exposed to the strongest pump power and it has a less efficient stimulated emission sequence than the Nd:YVO4 crystal. It will therefore convert the absorption into a lower gain than if the Nd:YVO4 crystal were placed upstream. This makes it possible to repress the threshold at which parasitic effects appear. In this case, it is also beneficial to partly preserve the Nd:YVO4 crystal so as to ensure sufficient longitudinal gain for the laser effect to be effective.

In the case of rods 2 composed of a single doping and of a single matrix or of several different dopings and/or of several different matrices, in order to obtain insensitivity to the variation in wavelength of the diodes 6A, the active medium possesses a doping and a length that are such that, with longitudinal pumping, the proportion of pump energy absorbed Abs for the least absorbent wavelength of the operational spectral range, is greater than about 90%. Therefore, Abs=1−exp(−α_{λ}L)>90%, i.e. α_{λ}L>2.3. Thus, as an illustration in the case in which α_{λ} (for λ=802 nm)=0.6 cm⁻¹ at the minimum absorption, it is necessary for the length L of doped material to be greater than 2.3/(α_{λ}, i.e. L>3.8 cm.

Moreover, in a preferred embodiment, said pumping system 6 comprises modules (or stacks) of diodes 6A, these being formed from semiconductors obtained from various wafers. The sum of the spectral emissions of the various semiconductors thus generates a broader spectrum than that of a single diode. In addition, each module of diodes 6A preferably includes an individual cooling means, thereby making it possible also to obtain a likewise spread spectral operation.

In another embodiment, the diodes 6A are not actively cooled, but dissipate energy, over a limited sequence in time, in a solid structure, the rise in temperature of which will limit their own temperature rise. The starting temperature and this temperature rise are such that their emission wavelength, throughout the sequence, remains within the operational spectral range so that, despite the possibility low starting temperature for the sequence and a drift in this temperature over the course of time, the laser source 1 remains quite stable in operation over the sequence without using active means for stabilizing the temperature.

Furthermore, in one particular embodiment, said pumping system 6 is formed so as to generate a pump beam 3 with stability of the energy deposited, stable to better than 20% over several tens of degrees.

Moreover, said laser source 5 also includes means (not shown) for generating at least two passes of the pump beam 3 in the active element 1.

In another particular embodiment (not shown), the pumping system 6 includes two pumping units that may pump the beam 2 via its two respective ends, and at least one dichroic mirror for splitting the pump beam 3 from the laser radiation 4. In this case, the rod 2 preferably has ends close to the entrance faces for the pumping, which are less doped and a center that is more doped. If one or more dichroic mirrors is used to pump the rod 2, the laser cavity into which the active medium is inserted may be bounded by Porro prisms, the radiation then being extracted via the center.

1. An active element for a laser source, said active element (1) comprising:
an elongate rod (2) which comprises a doped matrix capable of absorbing at least one pump beam (3) in order to amplify at least laser radiation (4) propagating longitudinally;
a first coating (12) that is placed on the periphery of said rod (2) and is capable of reflecting the pump beam (3); and
an absorption means (13) for absorbing radiation that passes through the periphery of said rod (2) and has a wavelength substantially equal to that of said laser radiation (4), wherein the length and the doping of said elongate rod (2) are such that the proportion of pump energy absorbed by said elongate rod (2) is greater than 90% for the wavelength of an operating spectral range that has the lowest absorption coefficient.

2. The active element as claimed in claim 1, wherein said first coating (12) is formed so as to also correspond to said absorption means (13).

3. The active element as claimed in claim 2, wherein the material of said first coating (12) is filled with an absorbent substance.

4. The active element as claimed in claim 1, wherein said absorption means (13) corresponds to a second coating (14) that is placed on the external face of said first coating (12).

5. The active element as claimed in claim 4, wherein said elongate rod (2) has a circular cross section, wherein said first coating (12) comprises an interface material (15), which provides a thermal and mechanical junction, which is placed on the periphery of said rod (2) and has a lower refractive index than said rod, and wherein said second coating (14) comprises a mount (16) made of absorbent material, which surrounds said rod (2) provided with said interface material (15).

6. The active element as claimed in claim 1, wherein said first coating (12) comprises a thin film having a lower refractive index than said rod (2).

7. The active element as claimed in claim 1, wherein said rod (2) has plane lateral faces (2A to 2D) and wherein said first coating (12) comprises plates (17A to 17D) that are welded to said plane lateral faces (2A to 2D) of said rod (2) and are made of a material having a lower refractive index than said rod (2).

8. The active element as claimed in claim 1, wherein said rod (12) is formed from at least one material having a longitudinal variation in doping, with the lowest doping limited to a predetermined value, on an entrance face (11) for the pump beam (3).

9. The active element as claimed in claim 8, wherein said material has a continuous longitudinal variation in doping.

10. The active element as claimed in claim 8, wherein said material has a stepped longitudinal variation in doping.

11. The active element as claimed in claim 9, wherein said material comprises a ceramic with a doping gradient.

12. The active element as claimed in claim 10, wherein said material comprises several differently doped crystals.

13. The active element as claimed in claim 12, wherein said material comprises an Nd:YAG crystal and an Nd:YVO4 crystal.

14. The active element as claimed in claim 13, wherein said Nd:YAG crystal is placed upstream of said Nd:YVO4 crystal.

15. A laser source comprising:
an active layer (1) for a laser source;
a pumping system (6) provided with laser diodes (6A) that are capable of emitting at least one pump beam (3);
an optical transport system (7) for directing the pump beam (3) emitted by said laser diodes (6A) into said active element (1) so as to obtain longitudinal pumping; and
an optical cavity (8) for extracting at least laser radiation (4),
wherein said active element (1) is of the type specified in claim 1.

16. The laser source as claimed in claim 14, wherein said pumping system (6) is formed so as to generate a pump beam (3) with stability of the energy deposited, stable to better than 20% over several tens of degrees.

17. The laser source as claimed in claim 15, wherein said pumping system (6) is formed so as to generate a pump beam (3) lying with a predetermined solid angle relative to said rod (2).

18. The laser source as claimed in claim 15, wherein said pumping system (6) comprises modules of diodes (6A), which modules are formed of semiconductors coming from various wafers.

19. The laser source as claimed in claim 18, wherein each module of diodes (6A) includes an individual cooling means.

20. The laser source as claimed in claim 15, which has a structure in which the laser diodes (6A) dissipate their energy.

21. The laser source as claimed in claim 15, which also includes means for generating at least one double pass of the pump beam (3) in the active element (1).

22. The laser source as claimed in claim 15, wherein said pumping system (6) comprises two pumping units designed to pump the rod (2) via its two ends.
